(19) United States
(12) Patent Application Publication
(10) Pub. No.: US 2010/0180005 A1
(43) Pub. Date: Jul. 15, 2010

(54) CACHE CYCLING

(75) Inventors: William B. Sebastian, Quincy, MA (US); Dan Newman, Littleton, MA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/571,288

(22) Filed: Sep. 30, 2009

Related U.S. Application Data
(60) Provisional application No. 61/143,933, filed on Jan. 12, 2009.

(51) Int. Cl. G06F 15/167; G06F 15/16

(52) U.S. Cl. 709/213; 709/219

(57) ABSTRACT

The present invention relates to methods, apparatus, and systems for implementing cache cycling. The system includes a gateway in communication with a satellite. The gateway includes a gateway accelerator module which further includes a proxy server. The proxy server is configured to receive the request for the new copy of the requested content and forward the request. Furthermore, the system includes a content provider in communication with the gateway. The content provider is configured to receive the content request and transmit the new copy of the requested content to the gateway. The gateway is configured to transmit the new copy of the content to the subscriber terminal via the satellite, and wherein the subscriber terminal is further configured to replace the requested content stored in the terminal cache module with the new copy of the requested content. The content stored in the terminal cache module is updated for subsequent requests.

### PRIORITY CLAIM

This application claims priority to U.S. Provisional Application No. 61/143,933, entitled WEB OPTIMIZATION OVER SATELLITE LINKS, filed on Jan. 12, 2009, which is incorporated by reference in its entirety for any and all purposes.

### RELATED APPLICATION

This application is related to co-pending application Attorney Docket Number 017018-019610US, entitled METHODS AND SYSTEMS FOR IMPLEMENTING URL MASKING, filed on ______, which is incorporated by references in its entirety for any and all purposes.

### FIELD OF THE INVENTION

The present invention relates, in general, to caching and, more particularly, to cache cycling.

### BACKGROUND

While using prefetching and caching may improve a subscriber's experience (e.g., through reduced download times for web objects), content providers may lose some control over content delivery and accounting. This may be undesirable for a number of reasons. One reason is that URL masking may compromise commercial interests of content providers. For example, advertising companies may rely on getting fresh requests to URLs to cycle different content, as well as to account for the number of site hits. Using cached information may limit content cycling and may make request and hit tracking more difficult. Another reasons is that providing subscribers with cached data may result in presenting the subscribers with different web experiences than if normal cycling of content was allowed.

FIG. 1 illustrates a system of implementing a prior art HTTP cache. The cache 102 receives a URL 101, and initially uses an index of URL 101's contents 104 to determine (process block 103) whether a fresh copy of the item is available. Freshness in this case is typically established using the standard HTTP rules, such as defined in RFC 2616, although HTTP caches can also be tuned to be more aggressive with respect to returning content that may not be fresh according to such rules. If the fresh copy is available, the cache retrieves (process block 109) the cached copy from a storage 108 and returns the retrieved object as a response (process block 110). No further action is need in this case. Alternatively, if the item is not in cache, a request 105 is uploaded to a web content server 106. When the response is received (process block 107), then returned (process block 110), a copy is added to storage 108, and index 104 is updated. There are significant shortcomings with this system; hence, improvements in the art are needed.

### BRIEF SUMMARY

Embodiments of the present invention are directed to a system for implementing cache cycling. The system includes a client configured to generate a content request. The system further includes a subscriber terminal which includes a terminal cache module and a terminal accelerator module which further includes a proxy client. The proxy client is configured to intercept the content request, access the terminal cache module, and determine that the requested content is stored in the terminal cache module, issue a request for a new copy of the requested content, and transmit the requested content stored in the terminal cache module to the client.

The system further includes a satellite in communication with the subscriber terminal, which is configured to transmit data. Further, the system includes a gateway in communication with the satellite. The gateway includes a gateway accelerator module which further includes a proxy server. The proxy server is configured to receive the request for the new copy of the requested content and forward the request. Furthermore, the system includes a content provider in communication with the gateway. The content provider is configured to receive the content request and transmit the new copy of the requested content to the gateway. The gateway is configured to transmit the new copy of the content to the subscriber terminal via the satellite, and wherein the subscriber terminal is further configured to replace the requested content stored in the terminal cache module with the new copy of the requested content. As such, the content stored in the terminal cache module is updated for subsequent requests.

Another embodiment is directed to a method of implementing cache cycling. The method includes generating, at a client, a content request, intercepting, at a subscriber terminal, the content request, and accessing a terminal cache module to determine that the requested content is stored in the terminal cache module. The method further includes issuing a request for a new copy of the requested content, transmitting the requested content stored in the terminal cache module to the client, and receiving, at a gateway, the request for the new copy of the requested content. Further, the method includes receiving, at a content provider, the content request and transmitting the new copy of the requested content to the gateway, transmitting the new copy of the content to the subscriber terminal, and replacing the requested content stored in the terminal cache module with the new copy of the requested content, such that the content stored in the terminal cache module is updated for subsequent requests.

In an alternative embodiment, a machine-readable medium is described. The machine-readable medium includes instructions for implementing cache cycling. The machine-readable medium includes instructions for generating, at a client, a content request, intercepting, at a subscriber terminal, the content request, and accessing a terminal cache module to determine that the requested content is stored in the terminal cache module. The machine-readable medium further includes instructions for issuing a request for a new copy of the requested content, transmitting the requested content stored in the terminal cache module to the client, and receiving, at a gateway, the request for the new copy of the requested content. Further, the machine-readable medium includes instructions for receiving, at a content provider, the content request and transmitting the new copy of the requested content to the gateway, transmitting the new copy of the content to the subscriber terminal, and replacing the requested content stored in the terminal cache module with the new copy of the requested content, such that the content stored in the terminal cache module is updated for subsequent requests.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a prior art system for implementing caching.

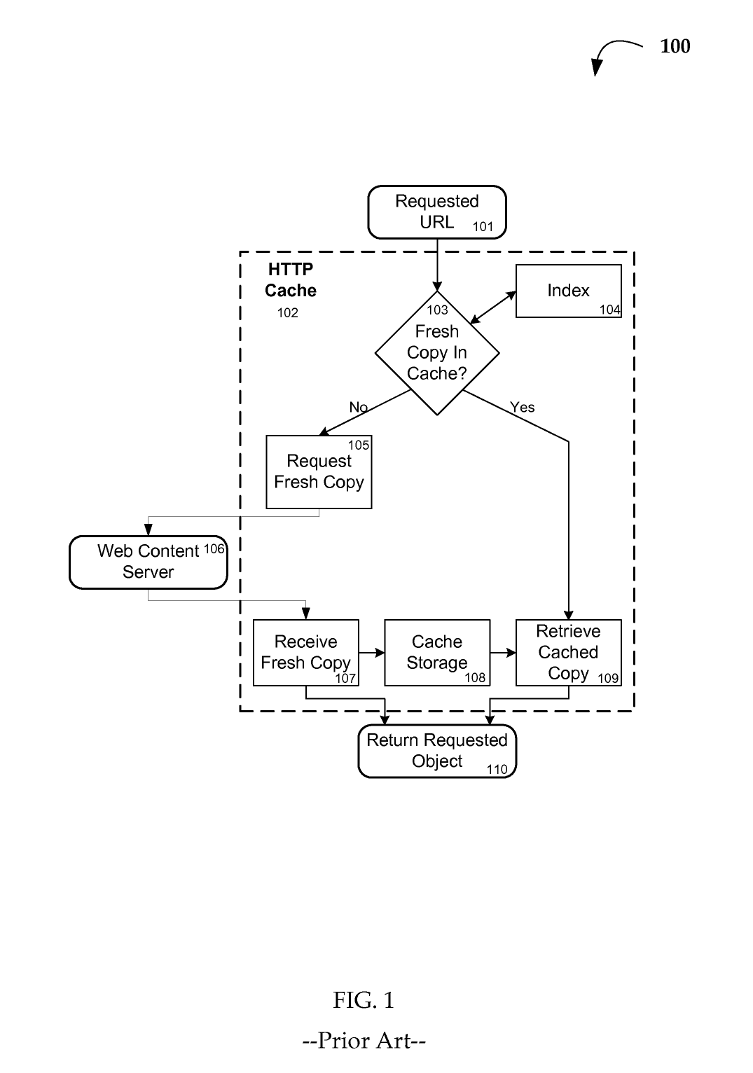

FIG. 2 is a block diagram illustrating a satellite communications system, which can be used in accordance with various embodiments of the invention.

FIG. 3 is a block diagram illustrating a satellite gateway, which can be used in accordance with various embodiments of the invention.

FIG. 4 is a block diagram illustrating multiple satellite subscriber terminals, which can be used in accordance with various embodiments of the invention.

FIG. 5 is a block diagram illustrating a system for implementing cache cycling, according to one embodiment of the present invention.

FIG. 6 is a block diagram further illustrating a system for implementing cache cycling, according to one embodiment of the present invention.

FIG. 7 is a generalized schematic diagram illustrating a computer system, in accordance with various embodiments of the invention.

FIG. 8 is a block diagram illustrating a networked system of computers, which can be used in accordance with various embodiments of the invention.

### DETAILED DESCRIPTION

The ensuing description provides exemplary embodiment(s) only and is not intended to limit the scope, applicability or configuration of the disclosure. Rather, the ensuing description of the exemplary embodiment(s) will provide those skilled in the art with an enabling description for implementing an exemplary embodiment. It should be understood that various changes may be made in the function and arrangement of elements without departing from the spirit and scope as set forth in the appended claims.

Aspects of the disclosure relate to cache cycling, which is used to issue fresh requests to content providers for website content each time a proxy server serves a request from cached data. Cache cycling allows fresh content to be supplied for each request when URL masking is used, as described in detail in co-pending application Attorney Docket Number 017018-019610US, entitled METHODS AND SYSTEMS FOR IMPLEMENTING URL MASKING, filed on ______, is which is incorporated by references in its entirety for any and all purposes. URL masking removes random elements from URL strings which are used to cycle through different content. Removing these random elements allows prefetching optimizations as well as caches to work effectively, but could interfere with the normal cycling of different content items for advertisements or other web elements. Cache cycling allows fresh content to be presented for each request while still allowing the performance benefits of caches and prefetching to be achieved. Furthermore, since using cached content reduces the apparent number of times a URL is requested, URL masking could interfere with the accounting of advertising revenue and other metrics based on the number of requests. Cache cycling maintains the request metrics while allowing the performance benefits of caching to be achieved.

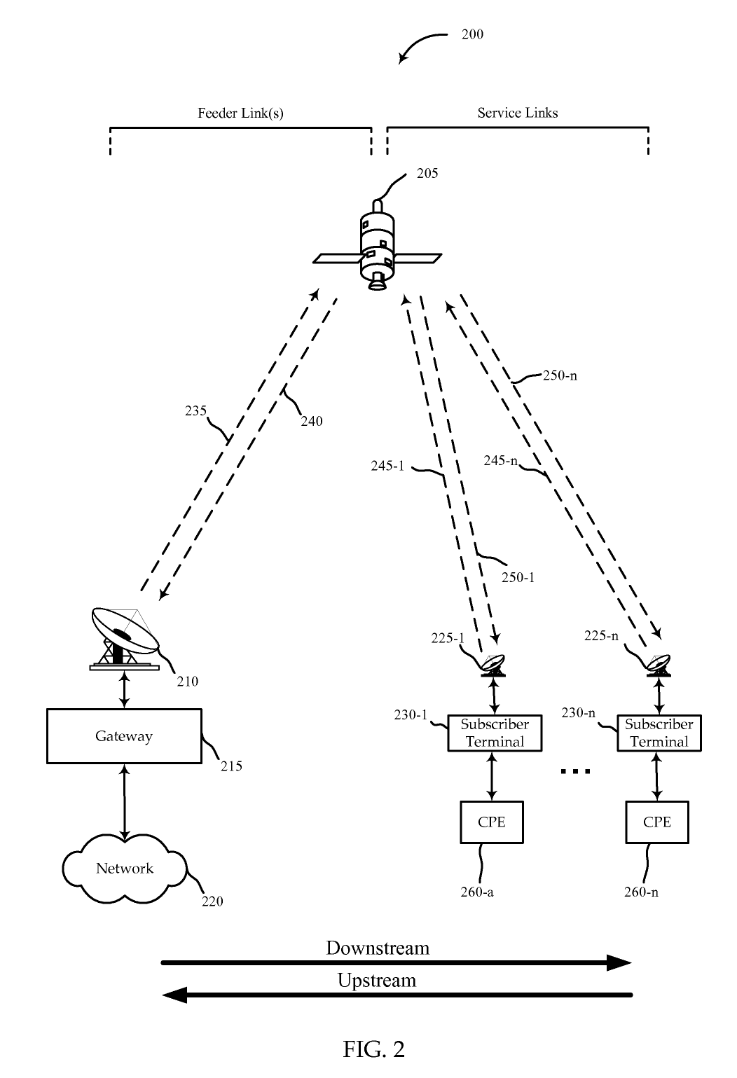

Referring first to FIG. 2, a module diagram is shown of a satellite communications system 200 for use with various embodiments of the invention. The satellite communications system 200 includes a network 220, such as the Internet, interfaced with a gateway 215 that is configured to communicate with one or more subscriber terminals 230, via a satellite 205. A gateway 215 is sometimes referred to as a hub or ground station. Subscriber terminals 230 are sometimes called modems, satellite modems, or user terminals. As noted above, although the communications system 200 is illustrated as a geostationary satellite 205 based communication system, it should be noted that various embodiments described herein are not limited to use in geostationary satellite-based systems; for example, some embodiments could be low earth orbit (“LEO”) satellite-based systems or aerial payloads not in orbit and held aloft by planes, blimps, weather balloons, etc. Other embodiments could have a number of satellites instead of just one.

The network 220 may be any type of network and can include, for example, the Internet, an Internet protocol (“IP”) network, an intranet, a wide-area network (“WAN”), a local-area network (“LAN”), a virtual private network (“VPN”), the Public Switched Telephone Network (“PSTN”), and/or any other type of network supporting data communication between devices described herein, in different embodiments. A network 220 may include both wired and wireless connections, including optical links. As illustrated in a number of embodiments, the network 220 may connect the gateway 215 with other gateways (not shown), which are also in communication with the satellite 205.

The gateway 215 provides an interface between the network 220 and the satellite 205. The gateway 215 may be configured to receive data and information directed to one or more subscriber terminals 230, and can format the data and information for delivery to the respective destination device via the satellite 205. Similarly, the gateway 215 may be configured to receive signals from the satellite 205 (e.g., from one or more subscriber terminals 230) directed to a destination in the network 220, and can process the received signals for transmission along the network 220.

A device (not shown) connected to the network 220 may communicate with one or more subscriber terminals 230. Data and information, for example IP datagrams, may be sent from a device in the network 220 to the gateway 215. It will be appreciated that the network 220 may be in further communication with a number of different types of providers, including content providers, application providers, service providers, etc. Further, in various embodiments, the providers may communicate content with the satellite communication system 200 through the network 220, or through other components of the system (e.g., directly through the gateway 215).

The gateway 215 may format frames in accordance with a physical layer definition for transmission to the satellite 205. A variety of physical layer transmission modulation and coding techniques may be used with certain embodiments of the invention, including those defined with the DVB-S2 standard. The link 235 from the gateway 215 to the satellite 205 may be referred to hereinafter as the downstream uplink 235. The gateway 215 uses the antenna 210 to transmit the content (e.g., via signals) to the satellite 205. In one embodiment, the antenna 210 comprises a parabolic reflector with high directivity in the direction of the satellite and low directivity in other directions. The antenna 210 may comprise a variety of alternative configurations and include operating features such as high isolation between orthogonal polarizations, high efficiency in the operational frequency bands, and low noise.

In one embodiment, a geostationary satellite 205 is configured to receive the signals from the location of antenna 210 and within the frequency band and specific polarization transmitted. The satellite 205 may, for example, use a reflector antenna, lens antenna, array antenna, active antenna, or other mechanism known in the art for reception of such signals. The satellite 205 may process the signals received from the gateway 215 and forward the signal from the gateway 215 containing the MAC frame to one or more subscriber terminals 230. In one embodiment, the satellite 205 operates in a multi-beam mode, transmitting a number of narrow beams, each directed at a different region of the earth, allowing for frequency re-use with a multicolor beam pattern.

With such a multibeam satellite 205, there may be any number of different signal switching configurations on the satellite 205, allowing signals from a single gateway 215 to be switched between different spot beams. In one embodiment, the satellite 205 may be configured as a “bent pipe” satellite, wherein the satellite may frequency-convert the received carrier signals before retransmitting these signals to their destination, but otherwise perform little or no other processing on the contents of the signals. There could be a single carrier signal for each service spot beam or multiple carriers in different embodiments. Similarly, single or multiple carrier signals could be used for the feeder spot beams. A variety of physical layer transmission modulation and coding techniques may be used by the satellite 205 in accordance with certain embodiments of the invention, including those defined with the DVB-S2 standard. For other embodiments, a number of configurations are possible (e.g., using LEO satellites, or using a mesh network instead of a star network), as will be evident to those skilled in the art.

The service signals transmitted from the satellite 205 may be received by one or more subscriber terminals 230, via the respective subscriber antenna 225. In one embodiment, the subscriber antenna 225 and terminal 230 together comprise a very small aperture terminal (“VSAT”), with the antenna 225 measuring approximately 0.6 meters in diameter and having approximately 2 watts of power. In other embodiments, a variety of other types of subscriber antennae 225 may be used at the subscriber terminal 230 to receive the signal from the satellite 205. The link 250 from the satellite 205 to the subscriber terminals 230 may be referred to hereinafter as the downstream downlink 250. Each of the subscriber terminals 230 may comprise a single user terminal or, alternatively, comprise a hub or router (not pictured) that is coupled to multiple user terminals.

In some embodiments, some or all of the subscriber terminals 230 are connected to consumer premises equipment (“CPE”) 260. CPE may include, for example, computers, local area networks, Internet appliances, wireless networks, etc. A subscriber terminal 230, for example 230-a, may transmit data and information to a network 220 destination via the satellite 205. The subscriber terminal 230 transmits the signals via the upstream uplink 245-a to the satellite 205 using the subscriber antenna 225-a. The link from the satellite 205 to the gateway 215 may be referred to hereinafter as the upstream downlink 240.

In various embodiments, one or more of the satellite links (e.g., 235, 240, 245, and/or 250) are capable of communicating using one or more communication schemes. In various embodiments, the communication schemes may be the same or different for different links. The communication schemes may include different types of coding and modulation schemes. For example, various satellite links may communicate using physical layer transmission modulation and coding techniques, adaptive coding and modulation schemes, etc. The communication schemes may also use one or more different types of multiplexing schemes, including Multi-Frequency Time-Division Multiple Access (“MF-TDMA”), Time Division Multiple Access (“TDMA”), Frequency Division Multiple Access (“FDMA”), Orthogonal Frequency Division Multiple Access (“OFDMA”), Code Division Multiple Access (“CDMA”), or any number of hybrid or other schemes known in the art.

In a given satellite spot beam, all customers serviced by the spot beam may be capable of receiving all the content traversing the spot beam by virtue of the fact that the satellite communications system 200 employs wireless communications via various antennae (e.g., 210 and 225). However, some of the content may not be intended for receipt by certain customers. As such, the satellite communications system 200 may use various techniques to “direct” content to a subscriber or group of subscribers. For example, the content may be tagged (e.g., using packet header information according to a transmission protocol) with a certain destination identifier (e.g., an IP address) or use different modcode points. Each subscriber terminal 230 may then be adapted to handle the received data according to the tags. For example, content destined for a particular subscriber terminal 230 may be passed on to its respective CPE 260, while content not destined for the subscriber terminal 230 may be ignored. In some cases, the subscriber terminal 230 caches information not destined for the associated CPE 260 for use if the information is later found to be useful in avoiding traffic over the satellite link.

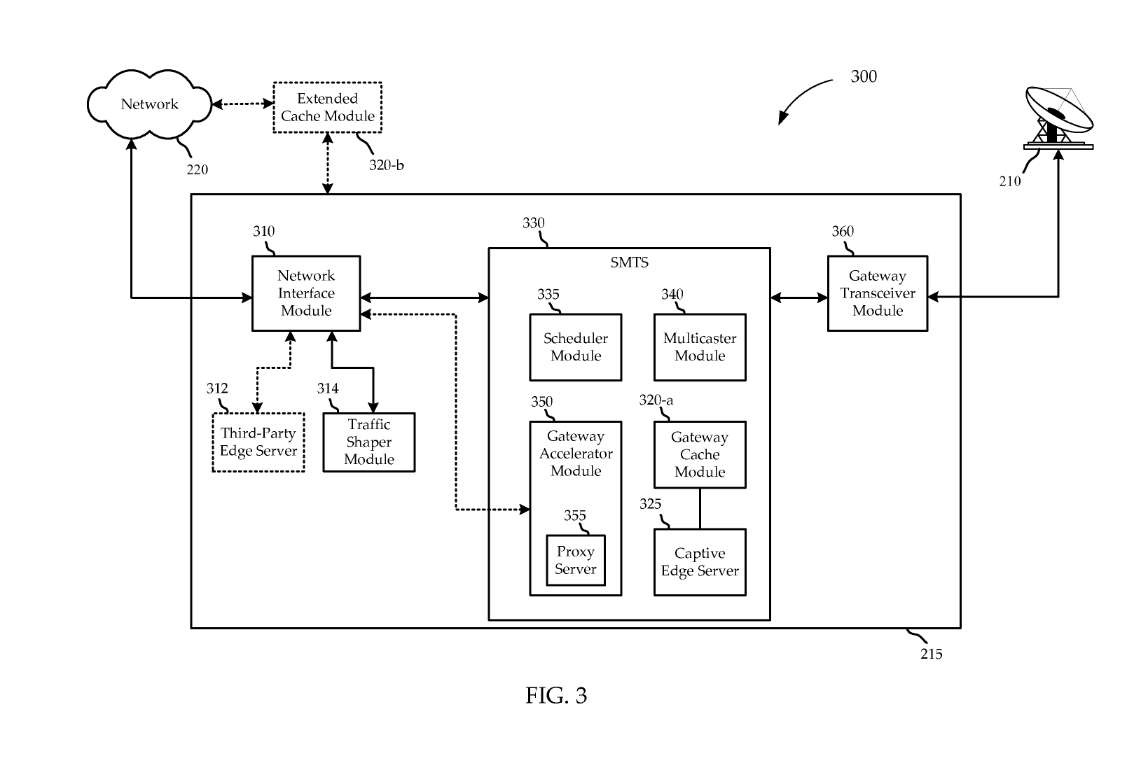

It will be appreciated that many embodiments of gateways are possible for use in embodiments of communication systems, like the satellite communication system 200 of FIG. 2. FIG. 3 shows a simplified block diagram 300 illustrating an embodiment of a gateway 215 coupled between the network 220 and an antenna 210, according to various embodiments of the invention. The gateway 215 has a number of components, including a network interface module 310, a satellite modem termination system (“SMTS”) 330, and a gateway transceiver module 360.

Components of the gateway 215 may be implemented, in whole or in part, in hardware. Thus, they may comprise one, or more, Application Specific Integrated Circuits (“ASICs”) adapted to perform a subset of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (“FPGAs”) and other Semi-Custom ICs), which may be programmed in any manner known in the art. Each may also be implemented, in whole or in part, with instructions embodied in a computer-readable medium, formatted to be executed by one or more general or application specific controllers.

Embodiments of the gateway 215 receive data from the network 220 (e.g., the network 220 of FIG. 2), including data destined for one or more subscribers in a spot beam. The data is received at the network interface module 310, which includes one or more components for interfacing with the network 220. For example, the network interface module 310 includes a network switch and a router.

In some embodiments, the network interface module 310 interfaces with other modules, including a third-party edge server 312 and/or a traffic shaper module 314. The third-party edge server 312 may be adapted to mirror content (e.g., implementing transparent mirroring, like would be performed in a point of presence (“POP”) of a content delivery network (“CDN”)) to the gateway 215. For example, the third-party edge server 312 may facilitate contractual relationships between content providers and service providers to move content closer to subscribers in the satellite communication network 200. The traffic shaper module 314 controls traffic from the network 220 through the gateway 215, for example, to help optimize performance of the satellite communication system 200 (e.g., by reducing latency, increasing effective bandwidth, etc.). In one embodiment, the traffic shaper module 314 delays packets in a traffic stream to conform to a predetermined traffic profile.

Traffic is passed from the network interface module 310 to the SMTS 330 to be handled by one or more of its component modules. In some embodiments, the SMTS 330 includes a scheduler module 335, a multicaster module 340, a gateway accelerator module 350, a gateway cache module 320-a, and/or a captive edge server 325. Embodiments of the scheduler module 335 are configured to provide various functions relating to scheduling the links of the satellite communication system 200 handled by the gateway 215. For example, the scheduler module 335 may manage link bandwidth by scheduling license grants within a spot beam. Embodiments of the multicaster module 340 are configured to provide various functions relating to multicasting of data over the links of the satellite communication system 200. For example, the multicaster module 340 may determine whether data is unicast or multicast to one or more subscribers. In some embodiments, the multicaster module 340 and/or scheduler module 335 contribute to determinations of what modcodes to use, whether data should or should not be sent as a function of data cached at destination subscriber terminals 230, how to handle certain types of encryption, etc.

Embodiments of the gateway accelerator module 350 provide various types of application, WAN/LAN, and/or other acceleration functionality. In one embodiment, the gateway accelerator module 350 implements functionality of AcceleNet applications from Intelligent Compression Technologies, Inc. (“ICT”), a division of ViaSat, Inc. This functionality may be used to exploit information from application layers of the protocol stack (e.g., layers 4-7 of the IP stack) through use of software or firmware operating in the subscriber terminal 230 and/or CPE 260.

In some embodiments, the gateway accelerator module 350 is adapted to provide high payload compression. For example, the gateway accelerator module 350 may compress payload such that over 75% of upload traffic when browsing the web is being used by transport management, rather than payload data. In other embodiments, functionality of the gateway accelerator module 350 is closely integrated with the satellite link through components of the SMTS 330 to reduce upload bandwidth requirements and/or to more efficiently schedule to satellite link (e.g., by communicating with the scheduler module 335). For example, the link layer may be used to determine whether packets are successfully delivered, and those packets can be tied more closely with the content they supported through application layer information. In certain embodiments, these and/or other functions of the gateway accelerator module 350 are provided by a proxy server 355 resident on (e.g., or in communication with) the gateway accelerator module 350.

In some embodiments, functionality of the SMTS 330 is provided through the gateway cache module 320. Embodiments of the gateway cache module 320 include any useful type of memory store for various types of functionality of the gateway 215. For example, the gateway cache module 320 may include volatile or non-volatile storage, servers, files, queues, etc. Further, in certain embodiments, storage functionality and/or capacity is shared between an integrated (e.g., on-board) gateway cache module 320-a and an extended (e.g., off-board) cache module 320-b. For example, the extended cache module 320-b may be accessible by the gateway 215 via the network 220.

In certain embodiments, the gateway cache module 320 is in communication with the captive edge server 325. In some embodiments, the captive edge server 325 provides functionality similar to that of the third-party edge server 312, including content mirroring. For example, the captive edge server 325 may facilitate different contractual relationships from those of the third-party edge server 312 (e.g., between the gateway 215 provider and various content providers).

It will be appreciated that the SMTS 330 may provide many different types of functionality. For example, embodiments of the SMTS 330 oversee a variety of decoding, interleaving, decryption, and unscrambling techniques. The SMTS 330 may also manage functions applicable to the communication of content downstream through the satellite 205 to one or more subscriber terminals 230. In certain embodiments, some or all of these downstream communication functions are handled by the gateway transceiver module 360.

Embodiments of the gateway transceiver module 360 encode and/or modulate data, using one or more error correction techniques, adaptive encoding techniques, baseband encapsulation, frame creation, etc. (e.g., using various modcodes, lookup tables, etc.). Other functions may also be performed by these components (e.g., by the SMTS 330), including upconverting, amplifying, filtering, tuning, tracking, etc. The gateway transceiver module 360 communicates data to one or more antennae 210 for transmission via the satellite 205 to the subscriber terminals 230.

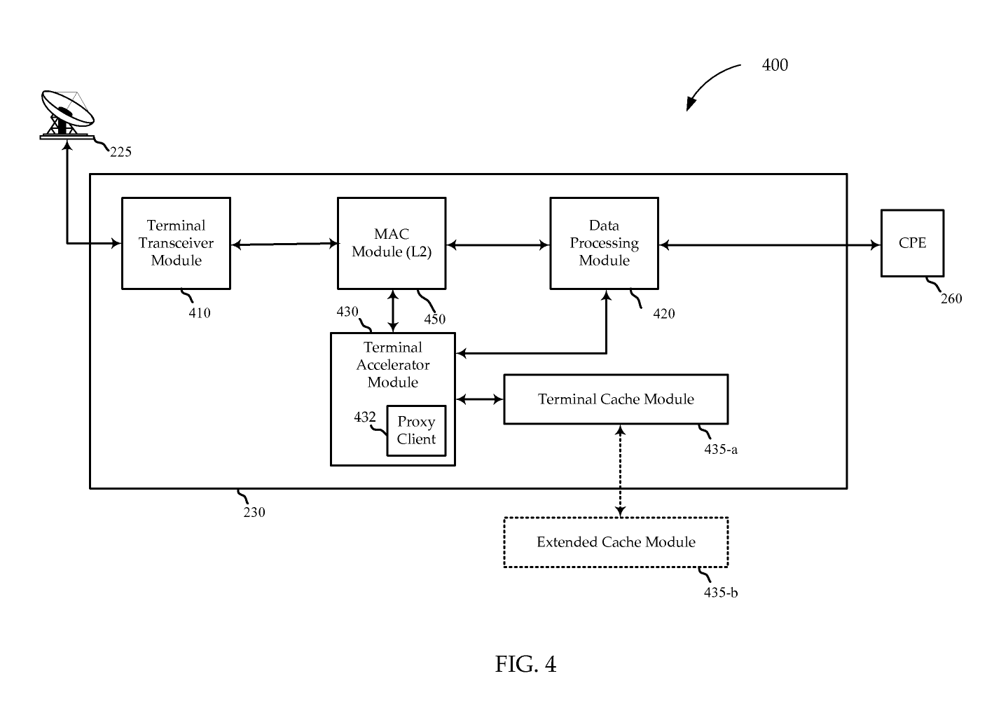

FIG. 4 shows a simplified block diagram 400 illustrating an embodiment of a subscriber terminal 230 coupled between the respective subscriber antenna 225 and the CPE 260, according to various embodiments of the invention. The subscriber terminal 230 includes a terminal transceiver module 410, a data processing module 420, a terminal accelerator module 430, a terminal cache module 435, and a MAC module 450. The components may be implemented, in whole or in part, in hardware. Thus, they may comprise one, or more, Application Specific Integrated Circuits (“ASICs”) adapted to perform a subset of the applicable functions in hardware. Alternatively, the functions may be performed by one or more other processing modules (or cores), on one or more integrated circuits. In other embodiments, other types of integrated circuits may be used (e.g., Structured/Platform ASICs, Field Programmable Gate

Arrays (“FPGAs”) and other Semi-Custom ICs), which may be programmed in any manner known in the art. Each may also be implemented, in whole or in part, with instructions embodied in a computer-readable medium, formatted to be executed by one or more general or application specific processors.

A signal from the subscriber antenna 225 is received by the subscriber terminal 230 at the terminal transceiver module 410. Embodiments of the terminal transceiver module 410 may amplify the signal, acquire the carrier, and/or downconvert the signal. In some embodiments, this functionality is performed by other components (either inside or outside the subscriber terminal 230). The downconverted signal is communicated to the data processing module 420 to be digitized and further processed.

Embodiments of the data processing module 420 provide various types of data processing functionality. For example, the data processing module 420 processes the received signal by interpreting (e.g., and decoding) modulation and/or coding schemes, interpreting multiplexed data streams, filtering the digitized signal, parsing the digitized signal into various types of information (e.g., by extracting the physical layer header), etc.

In some embodiments, the data processing module 420 is in communication with the terminal accelerator module 430. In some embodiments, the terminal accelerator module 430 provides substantially the same functionality as the gateway accelerator module 250, including various types of applications, WAN/LAN, and/or other acceleration functionality. In one embodiment, the terminal accelerator module 430 implements functionality of AcceleNet applications, like interpreting data communicated by the gateway 215 using high payload compression, handling various prefetching functions, parsing scripts to interpret requests, etc. In certain embodiments, these and/or other functions of the terminal accelerator module 430 are provided by a proxy client 432 resident on (e.g., or in communication with) the terminal accelerator module 430.

In some embodiments, output from the data processing module 420 and/or the terminal accelerator module 430 is stored in the terminal cache module 435. Further, the data processing module 420 and/or the terminal accelerator module 430 may be configured to determine what data should be stored in the terminal cache module 435 and which data should not (e.g., which data should be passed to the CPE 260). It will be appreciated that the terminal cache module 435 may include any useful type of memory store for various types of functionality of the subscriber terminal 230. For example, the terminal cache module 435 may include volatile or non-volatile storage, servers, files, queues, etc.

In certain embodiments, storage functionality and/or capacity is shared between an integrated (e.g., on-board) terminal cache module 435-a and an extended (e.g., off-board) cache module 435-b. For example, the extended cache module 435-b may be implemented in various ways, including as an attached peripheral device (e.g., a thumb drive, USB hard drive, etc.), a wireless peripheral device (e.g., a wireless hard drive), a networked peripheral device (e.g., a networked server), etc. In one embodiment, functionality of the terminal cache module 435 is implemented as storage integrated in the CPE 260 of FIG. 2.

Data destined for the CPE 260 (e.g., data not stored in the terminal cache module 435 or data retrieved from the terminal cache module 435) is communicated to the MAC module 450. Embodiments of the MAC module 450 prepare data for communication to the CPE 260. For example, the MAC module 450 may modulate, encode, filter, decrypt, and/or otherwise process the data to be compatible with the CPE 260.

In certain embodiments, the subscriber terminal 230 is configured to transmit data back to the gateway 215. Embodiments of the terminal transceiver module 410, the data processing module 420, the terminal accelerator module 430, the terminal cache module 435, and/or the MAC module 450 are configured to provide functionality for communicating information back through the satellite communication system 200 (e.g., for directing provision of services). For example, information about what is stored in the terminal cache module 435 may be sent back to the gateway 215 for limiting repetitious file transfers, as described more fully below.

It will be appreciated that the satellite communications system 200 may be used to provide different types of communication services to subscribers. For example, the satellite communications system 200 may provide content from the network 220 to a subscriber's CPE 260, including Internet content, broadcast television and radio content, on-demand content, voice-over-Internet-protocol (“VoIP”) content, and/or any other type of desired content. It will be further appreciated that this content may be communicated to subscribers in different ways, including through unicast, multicast, broadcast, and/or other communications.

Embodiments of the invention include methods, systems, and devices that use multicasting, caching, and/or other techniques to provide novel satellite communication functionality. It will be appreciated that other components and systems may be used to provide functionality of the various embodiments described herein. As such, descriptions of various embodiments in the context of components and functionality of FIGS. 2-4 are intended only for clarity, and should not be construed as limiting the scope of the invention.

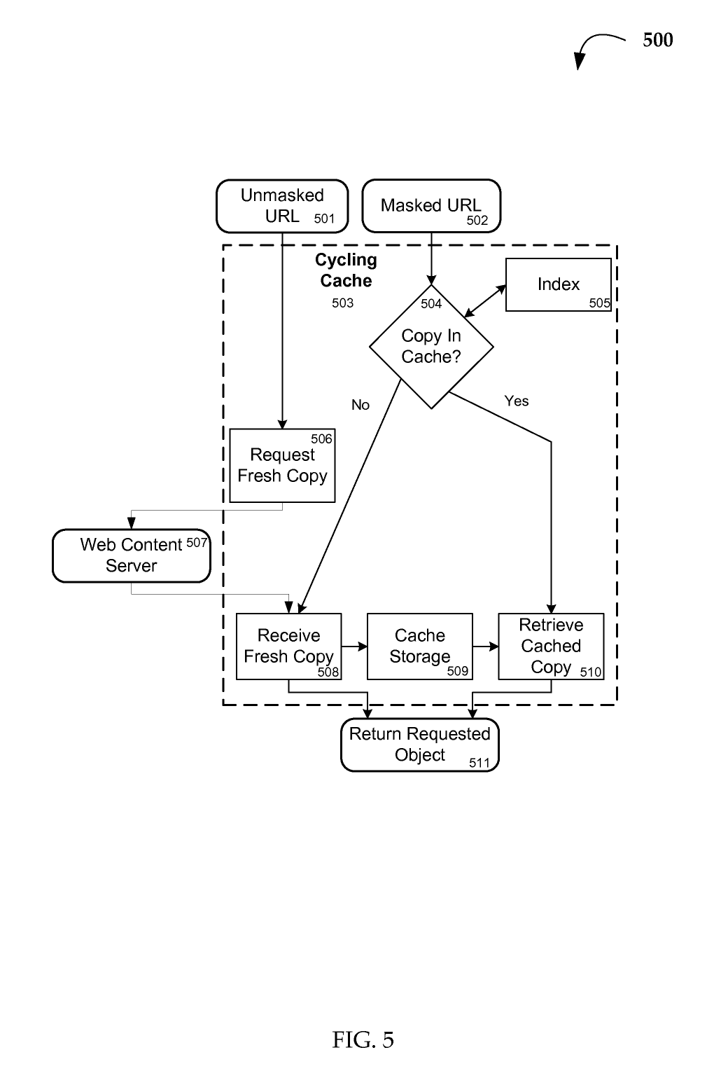

FIG. 5 illustrates how a cache with cache cycling is used in conjunction with URL masking, according to embodiments of the present invention. The input to the cache may include both a normal unmasked URL 501 and a masked URL 502 (using the techniques described in co-pending application Attorney Docket Number 017018-019610US, entitled METHODS AND SYSTEMS FOR IMPLEMENTING URL MASKING, filed on ______). For these purposes, the masked bytes in the URL string can be filled with default placeholders, such as the character ‘0’, or the like. As a result, the impact of random values in the URL string have been removed so that all URLs that differ only by the random elements will present the same masked URL at process block 502.

A cache 503 then checks an index 505 to determine whether, the object that was retrieved in response to a request for a URL that had the same masked URL, is in cache 503. If a response is in cache and sufficiently fresh, it is retrieved (process block 510) from a storage 509 and returned (process block 511) to the user (e.g., client browser, etc.). In this case, freshness may be determined by special rules rather than using RFC 2616, as the expiration times provided in the HTTP header may not support caching. If a cached copy can be used, the user obtains the performance benefits from avoiding the wait for a response from, for example, a web content server.

For each masked URL 502 that is received, an unmasked URL 501 is also supplied. The unmasked URL includes the random elements created in, for example, the original Java script, and each of these URLs would be unique. A fresh request 506 for the unmasked URL 501 is then sent to a web content server 507, regardless of whether a cached copy of the masked URL exists. When the response is received (process block 508), the response is added to cache storage 509 as the new entry for the masked URL 502, and index 505 is updated. If a sufficiently fresh cache entry is not found at process block 504, the cache waits for the response at process block 508, and then returns a copy to the user at process block 511.

In a further embodiment, cycling cache 503 may be implemented in either Terminal Cache Module 435-A or Gateway Cache Module 220-A. When used on the terminal side, cycling cache 503 allows for a response to be sent immediately to CPE 260 without waiting for a copy to be fetched or prefetched from content server 507. If a cached response was provided at process block 510, then the fresh copy received at process block 508 may not be considered time-critical, in that the customer has already received a response. In this case the transfer of this data can be done at a low priority so as not to interfere with time-sensitive transfers. Masked URL 502 can be generated from Unmasked URL 502 at the same time that the mask is used to check for matches with prefetched objects.

When used cycling cache 503 is implemented on the gateway side, cycling cache 503 may be used to provide fast responses to prefetch requests, as it avoids the need to wait for a response from content server 507. The URL masks are generated at the same time that the embedded URLs are identified in, for example, the Java scripts within the HTML or other web objects, so that masked URL 502 can be presented along with unmasked URL 501 to cycling cache 503.

In a further embodiment, each time a cached object is used, a fresh copy of the content may be requested. As such, the cache is cycled, and the client receives content that is one cycle old, but the same number of external “hit” are accounted. Furthermore, the client is not required to wait for the fresh copy of the content because the client is able to quickly render the cached copy, and the next time the content is requested the previously fresh copy will be rendered to the client, and another fresh copy with be retrieved, and so forth.

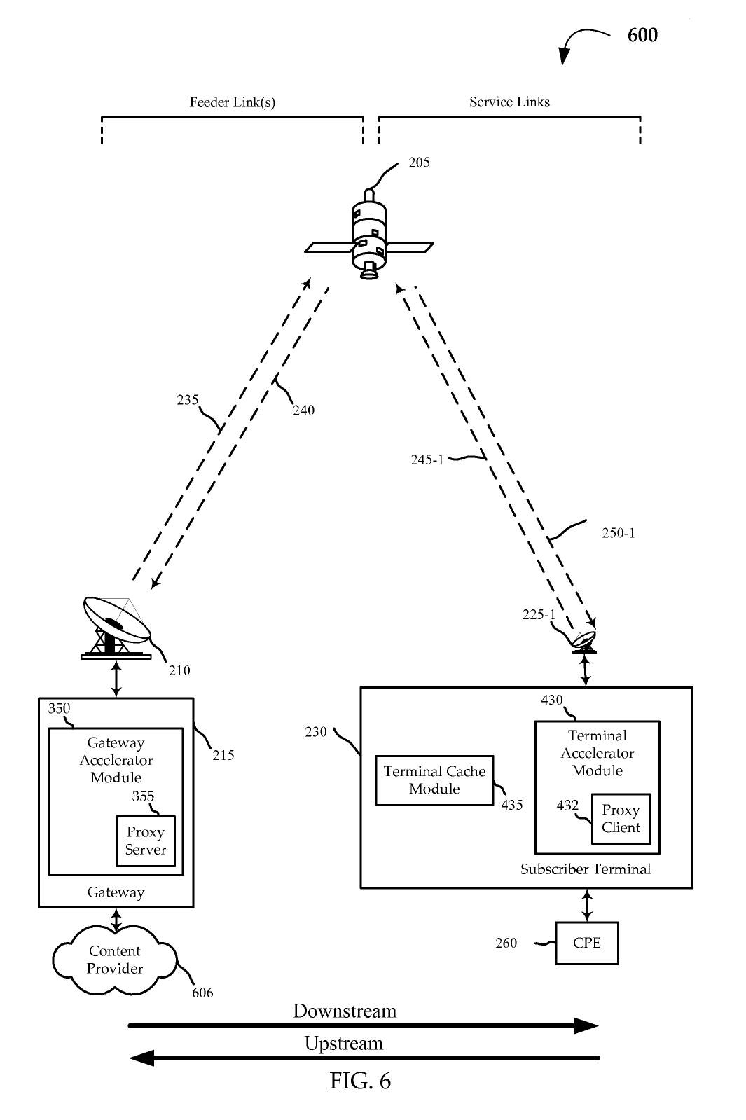

Referring now to FIG. 6, which illustrates a system 600 for implementing cache cycling, in accordance with aspects of the present invention. In one embodiment, system 600 may include elements from FIGS. 2-4, as well as a content provider 605. According to embodiments of the present invention, each time system 600 serves a request from cached data stored in terminal cache module 435, proxy server 255 in the gateway 215 may issue a fresh request to content provider 605 for the cached content. When the response to the request arrives, new objects may replace the cached copies of those objects, for use in serving the next request for that URL to CPE 260. In this way, content provider 605 may receive the same number of requests and may cycle through the same content, while providing CPE 260 with benefits of prefetched/cached content.

For example, a request may be made by a web browser for a URL at CPE 260. Proxy client 432 implemented in subscriber terminal 230 may determine (e.g., as a result of cache-busting techniques discussed above and in co-pending application Attorney Docket Number 017018-019610US, entitled METHODS AND SYSTEMS FOR IMPLEMENTING URL MASKING) that cached copies of the requested objects are available in terminal cache module 435. The proxy client then issues a fresh request to proxy server 255 in gateway 215 according to the requested content (e.g., with or without masking cache-busting portions of URL strings). While the request is being processed and new objects are being retrieved, locally cached copies of the objects are then passed to CPE 260's browser for rendering. As such, the web browser may immediately begin to render objects out of terminal cache module 435 without waiting for requests to be fulfilled over satellite 205; while in the meantime, cached objects are replaced with new versions as the requests are fulfilled.

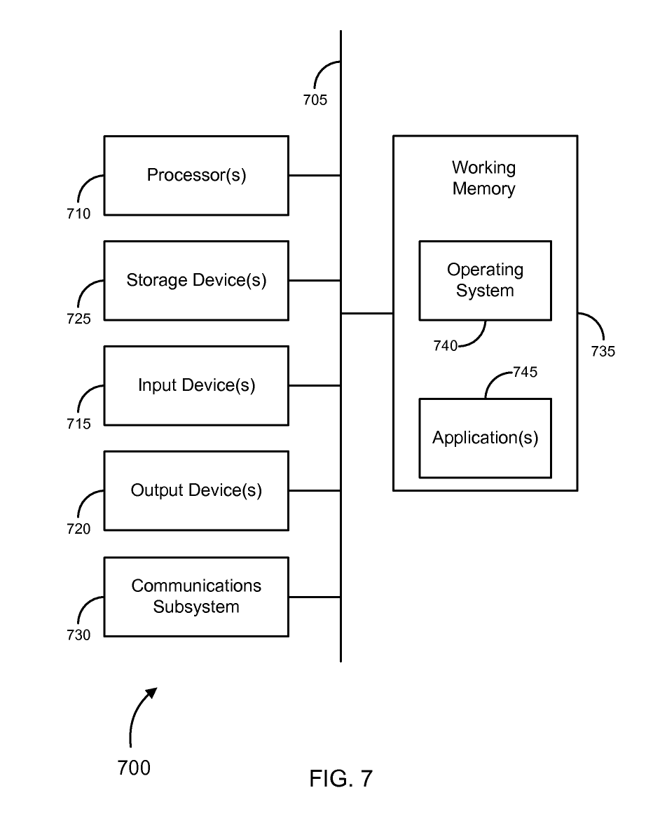

FIG. 7 provides a schematic illustration of one embodiment of a computer system 700 that can perform the methods of the invention. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements can include one or more processors 710, including without limitation one or more general-purpose processors and/or one or more special-purpose processors (such as digital signal processing chips, graphics acceleration chips, and/or the like); one or more input devices 715, which can include without limitation a mouse, a keyboard and/or the like; and one or more output devices 720, which can include without limitation a display device, a printer and/or the like.

The computer system 700 may further include (and/or be in communication with) one or more storage devices 725, which can comprise, without limitation, local and/or network accessible storage and/or can include, without limitation, a disk drive, a drive array, an optical storage device, a solid-state storage device such as a random access memory (“RAM”) and/or a read-only memory (“ROM”), which can be programmable, flash-updateable and/or the like. The computer system 700 might also include a communications subsystem 730, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740 and/or other code, such as one or more application programs 745, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 700) to perform methods of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another machine-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various machine-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 725. Volatile media includes, without limitation, dynamic memory, such as the working memory 735. Transmission media includes coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves (including without limitation, radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc., carried by the signals) to the working memory 735, from which the processor(s) 705 retrieves and executes the instructions. The instructions received by the working memory 735 may optionally be stored on a storage device 725 either before or after execution by the processor(s) 710.

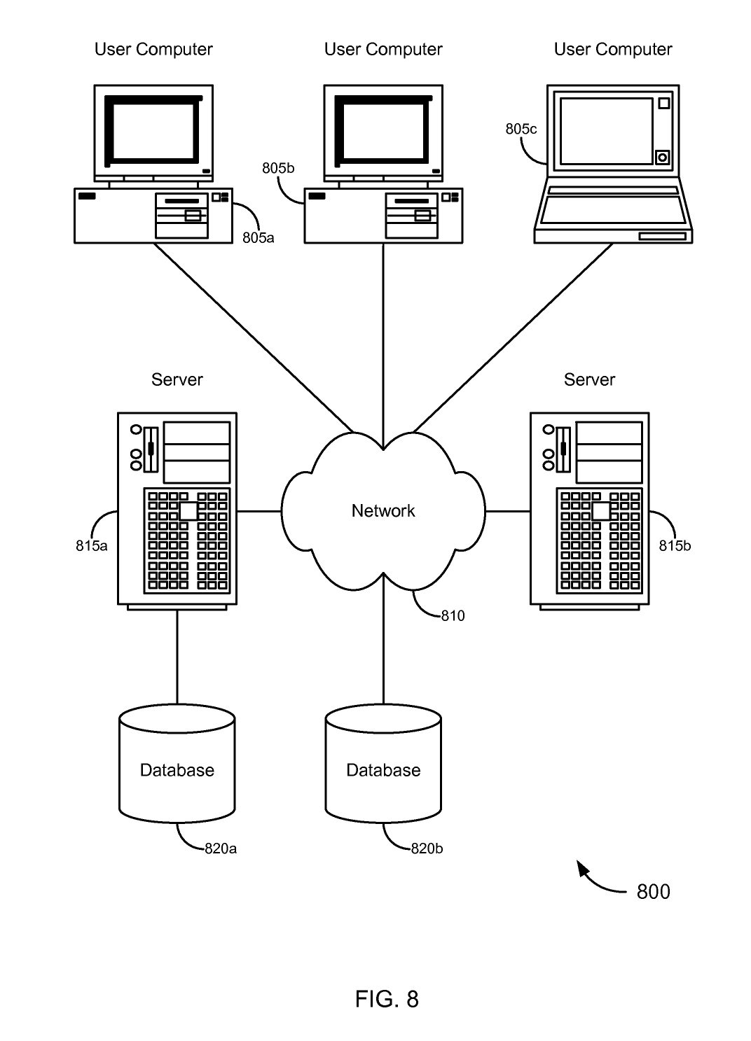

A set of embodiments comprises systems for implementing dedicated shared byte caches. Merely by way of example, FIG. 8 illustrates a schematic diagram of a system 800 that can be used in accordance with one set of embodiments. The system 800 can include one or more user computers 805. The user computers 805 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 805 can also have any of a variety of applications, including one or more applications configured to perform methods of the invention, as well as one or more office applications, database client and/or server applications, and web browser applications. Alternatively, the user computers 805 can be any other electronic device, such as a thin-client computer, Internet-enabled mobile telephone, and/or personal digital assistant (PDA), capable of communicating via a network (e.g., the network 810 described below) and/or displaying and navigating web pages or other types of electronic documents. Although the exemplary system 800 is shown with three user computers 805, any number of user computers can be supported.

Certain embodiments of the invention operate in a networked environment, which can include a network 810. The network 810 can be any type of network familiar to those skilled in the art that can support data communications using any of a variety of commercially available protocols, including without limitation TCP/IP, SNA, IPX, AppleTalk, and the like. Merely by way of example, the network 810 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 815. Each of the server computers 815 may be configured with an operating system, including without limitation any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 may be a web server, which can be used, merely by way of example, to process requests for web pages or other electronic documents from user computers 805. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 805 to perform methods of the invention.

The server computers 815, in some embodiments, might include one or more application servers, which can include one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 805 and/or another server 815. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 805 via a web server (as described above, for example). Similarly, a web server might receive web page requests and/or input data from a user computer 805 and/or forward the web page requests and/or input data to an application server. In some cases a web server may be integrated with an application server.

In accordance with further embodiments, one or more servers 815 can function as a file server and/or can include one or more of the files (e.g., application code, data files, etc.)

necessary to implement methods of the invention incorporated by an application running on a user computer 805 and/or another server 815. Alternatively, as those skilled in the art will appreciate, a file server can include all necessary files, allowing such an application to be invoked remotely by a user computer 805 and/or server 815. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820. The location of the database(s) 820 is discretionary: merely by way of example, a database 820a might reside on a storage medium local to (and/or resident in) a server 815a (and/or a user computer 805). Alternatively, a database 820b can be remote from any or all of the computers 805, 815, so long as the database can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A system for implementing cache cycling, the system comprising:
a client configured to generate a content request;
a subscriber terminal including a terminal cache module and a terminal accelerator module which includes a proxy client, wherein the proxy client is configured to intercept the content request, access the terminal cache module, and determine that the requested content is stored in the terminal cache module, issue a request for a new copy of the requested content, and transmit the requested content stored in the terminal cache module to the client;
a satellite in communication with the subscriber terminal, the satellite configured to transmit data;
a gateway in communication with the satellite, the gateway including a gateway accelerator module which includes a proxy server, the proxy server configured to receive the request for the new copy of the requested content and forward the request; and
a content provider in communication with the gateway, the content provider configured to receive the content request and transmit the new copy of the requested content to the gateway,
wherein the gateway is configured to transmit the new copy of the content to the subscriber terminal via the satellite; and
wherein the subscriber terminal is further configured to replace the requested content stored in the terminal cache module with the new copy of the requested content, such that the content stored in the terminal cache module is updated for subsequent requests.

2. A system for implementing cache cycling as in claim 1, wherein the content request includes a URL string for locating the requested content.

3. A system for implementing cache cycling as in claim 2, wherein the URL string comprises a masked URL string.

4. A system for implementing cache cycling as in claim 3, wherein a masked URL string comprise at least a portion of the URL string being randomly generated, and the masked URL string removed and/or replaces the at least a random portion of the URL string.

5. A system for implementing cache cycling as in claim 2, wherein the terminal accelerator module is further configured to determine portions of the URL string that are randomly generated for each request according to a particular random generation policy.

6. A system for implementing cache cycling as in claim 5, wherein the terminal accelerator module is further configured to generate a random string according to the random generation policy and insert the random string into the URL string in order to request the new copy of the requested content.

7. A system for implementing cache cycling as in claim 1, wherein the requested content comprises advertising content.

8. A system for implementing cache cycling as in claim 7, wherein the request for the advertising content includes cookies, client targeting parameters, and localization information associated with the request.

9. A system for implementing cache cycling as in claim 9, wherein the advertising content includes advertising accounting requirements, and as such, the requesting of the new copy of the requested content maintains the advertising accounting requirements.

10. A system for implementing cache cycling as in claim 1, wherein the satellite comprises a bent pipe satellite.

11. A system for implementing cache cycling as in claim 1, wherein the new copy of the requested content comprises a fresh copy of the requested content.

12. A system for implementing cache cycling as in claim 1, wherein the client is further configured to render the requested content.

13. A system for implementing cache cycling as in claim 1, wherein the terminal cache module is further configured to stored the new copy of the requested content.

14. A method of implementing cache cycling, the method comprising:
generating, at a client, a content request;
intercepting, at a subscriber terminal, the content request;
accessing a terminal cache module to determine that the requested content is stored in the terminal cache module;
issuing a request for a new copy of the requested content;
transmitting the requested content stored in the terminal cache module to the client;
receiving, at a gateway, the request for the new copy of the requested content;
receiving, at a content provider, the content request and transmitting the new copy of the requested content to the gateway;
transmitting the new copy of the content to the subscriber terminal; and
replacing the requested content stored in the terminal cache module with the new copy of the requested content, such that the content stored in the terminal cache module is updated for subsequent requests.

15. A method of implementing cache cycling as in claim 14, further comprising rendering the requested content in the client's browser.

16. A method of implementing cache cycling as in claim 14, wherein the content request includes a URL string for locating the requested content.

17. A method of implementing cache cycling as in claim 14, further comprising determining portions of the URL string that are randomly generated for each request according to a particular random generation policy.

18. A method of implementing cache cycling as in claim 17, further comprising generating a random string according to the random generation policy.

19. A method of implementing cache cycling as in claim 18, further comprising inserting the random string into the URL string in order to request the new copy of the requested content.

20. A method of implementing cache cycling as in claim 14, wherein the rested content comprises an HTTP request.

21. A machine-readable medium having sets of instructions which, when executed by a machine, cause the machine to:
generate, at a client, a content request;
intercept, at a subscriber terminal, the content request;
access a terminal cache module to determine that the requested content is stored in the terminal cache module;
issue a request for a new copy of the requested content;
transmit the requested content stored in the terminal cache module to the client;
receive, at a gateway, the request for the new copy of the requested content;
receive, at a content provider, the content request and transmitting the new copy of the requested content to the gateway;
transmit the new copy of the content to the subscriber terminal; and
replace the requested content stored in the terminal cache module with the new copy of the requested content, such that the content stored in the terminal cache module is updated for subsequent requests.

22. The machine-readable medium as in claim 21, wherein the sets of instructions, when further executed by the machine, cause the machine to store the new copy of the requested content at the terminal cache module.
